(19) United States
(12) Patent Application Publication
(10) Pub. No.: US 2025/0193281 A1
(43) Pub. Date: Jun. 12, 2025

(54) BATTERY DATA MANAGEMENT METHOD FOR VEHICLE, SYSTEM, SERVER AND VEHICLE COMMUNICATION APPARATUS

(71) Applicant: Autel Digital Power Co., Ltd., Shenzhen (CN)

(72) Inventors: Xiaojie SHEN, Shenzhen (CN); Xinguang TANG, Shenzhen (CN); Chu JIANG, Shenzhen (CN)

(73) Assignee: Autel Digital Power Co., Ltd., Shenzhen, GD (CN)

(21) Appl. No.: 18/845,422

(22) PCT Filed: Feb. 16, 2023
(86) PCT No.: PCT/CN2023/076466

§ 371 Date: Sep. 9, 2024

(30) Foreign Application Priority Data
Mar. 10, 2022 (CN) 202210237895.5

(51) Int. Cl. H04L 67/12; B60L 58/16; H01M 10/42

(52) U.S. Cl. CPC H04L 67/12; B60L 58/16; H01M 10/425; H01M 2010/4271; H01M 2220/20

(57) ABSTRACT

A battery data management method for a vehicle is provided by embodiments of the present disclosure. The method includes: transmitting, by a vehicle communication apparatus, a unique identifier acquisition request to a cloud server; determining, by the cloud server, whether the vehicle supports reading the vehicle identification number according to the target vehicle type information; when the vehicle supports, acquiring, by the cloud server, the vehicle identification number via the vehicle communication apparatus, and generating a first unique identifier according to the vehicle identification number and the target vehicle type information; and when the vehicle does not support, generating, by the cloud server, a second unique identifier according to a vehicle communication apparatus identification, a user identification and the target vehicle type information acquired from the vehicle communication apparatus.

### CROSS-REFERENCE TO RELATED APPLICATIONS

This application is the National Stage Application of International Patent Application No. PCT/CN2023/076466 filed on Feb. 16, 2023, which claims priority to Chinese Patent Application No. 202210237895.5, entitled “BATTERY DATA MANAGEMENT METHOD FOR VEHICLE, SYSTEM, CLOUD SERVER AND VEHICLE COMMUNICATION APPARATUS,” filed on Mar. 10, 2022, the entire disclosures of which are incorporated herein by reference for all purposes.

### FIELD

The present disclosure relates to the field of new energy vehicles, and in particular to a battery data management method for vehicle, a system, a cloud server and a vehicle communication apparatus.

### BACKGROUND

New energy vehicles refer to vehicles that employ unconventional vehicle fuels as a power source (e.g., power batteries). For new energy vehicles using power battery as power source, power battery is the core component on the vehicle, and the safety of power battery is a matter of driving safety. Therefore, accurately evaluating the health status of power battery to ensure driving safety is an urgent concern for the vehicle owners.

As an electrochemical form of energy storage carrier, the internal chemical reaction of power battery is carried out at anytime and anywhere, thus it is difficult to directly monitor. Although a battery management system (BMS) on an automobile can monitor the health status of a power battery in real time and make protective measures when the power battery fails, the accuracy of the battery management system in evaluating the health status of the power battery is not high enough to ensure driving safety.

### SUMMARY

Embodiments of the present disclosure provide a battery data management method for vehicle, a system, a cloud server and a vehicle communication apparatus, which can improve the accuracy of a power battery health status evaluation.

In a first aspect, some embodiments of the present disclosure provide a battery data management method for a vehicle, applied to a battery data management system, where the battery data management system includes a vehicle communication apparatus and a cloud server, the vehicle communication apparatus is configured to be communicatively connected with the vehicle and the cloud server, and the cloud server is configured to be further communicatively connected with the user terminal, where the method includes: transmitting, by the vehicle communication apparatus, a unique identifier acquisition request to the cloud server, where a unique identifier is configured to bind battery data acquired by the vehicle communication apparatus from the vehicle; in response to receiving, by the cloud server, the unique identifier acquisition request, acquiring, by the cloud server, target vehicle type information from the user terminal, and determining, by the cloud server, whether the vehicle supports reading a vehicle identification number according to the target vehicle type information; and in response to a first determination that the vehicle supports reading the vehicle identification number, acquiring, by the cloud server, the vehicle identification number via the vehicle communication apparatus, generating, by the cloud server, a first unique identifier according to the vehicle identification number and the target vehicle type information, and transmitting, by the cloud server, the first unique identifier to the vehicle communication apparatus; or in response to a second determination that the vehicle does not support reading the vehicle identification number, acquiring, by the cloud server, a vehicle communication apparatus identification from the vehicle communication apparatus and a user identification from the user terminal, generating, by the cloud server, a second unique identifier according to the vehicle communication apparatus identification, the user identification and the target vehicle type information, and transmitting, by the cloud server, the second unique identifier to the vehicle communication apparatus.

In a second aspect, some embodiments of the present disclosure provide a battery data management method for a vehicle. The method includes: acquiring, by a cloud server, target vehicle type information transmitted by a user terminal in response to receiving, by the cloud server, a unique identifier acquisition request transmitted by a vehicle communication apparatus, where a unique identifier is configured to bind battery data acquired by the vehicle communication apparatus from a vehicle; determining, by the cloud server, whether the vehicle supports reading a vehicle identification number according to the target vehicle type information; and in response to a first determination that the vehicle supports reading the vehicle identification number, generating, by the cloud server, a first unique identifier according to the vehicle identification number and the target vehicle type information, and transmitting, by the cloud server, the first unique identifier to the vehicle communication apparatus; or in response to a second determination that the vehicle does not support reading the vehicle identification number, generating, by the cloud server, a second unique identifier according to a vehicle communication apparatus identification, a user identification, and the target vehicle type information, and transmitting, by the cloud server, the second unique identifier to the vehicle communication apparatus.

In a third aspect, some embodiments of the present disclosure provide a battery data management method for a vehicle, applied to a vehicle communication apparatus, the method including: transmitting a unique identifier acquisition request to a cloud server, so that the cloud server generates a first unique identifier or a second unique identifier for binding the battery data, where the first unique identifier is generated by the cloud server according to the vehicle identification number and the target vehicle type information when the cloud server determines that the vehicle supports reading the vehicle identification number according to the target vehicle type information transmitted by the user terminal; where the second unique identifier is generated by the cloud server according to the vehicle communication apparatus identifier, the user identification and the target vehicle type information when the cloud server determines that the vehicle does not support reading the vehicle identification number according to the target vehicle type information transmitted by the user terminal; and receiving a unique identifier transmitted by the cloud server.

In a fourth aspect, an embodiment of the present disclosure provides a cloud server, including: a first communicator; at least one first processor electrically coupled to the first communicator; and a first memory communicatively connected with the at least one first processor; where the first memory stores instructions executable by the at least one first processor to enable the at least one first processor to perform the battery data management method as described above.

In a fifth aspect, an embodiment of the present disclosure provides a vehicle communication apparatus, including: a second communicator; at least one second processor electrically coupled to the second communicator; and a second memory communicatively connected with the at least one second processor; where the second memory stores instructions executable by the at least one second processor to enable the at least one second processor to perform the battery data management method as described above.

In a sixth aspect, an embodiment of the present disclosure provides a battery data management system, including: the cloud server as described above; the vehicle communication apparatus as described above, the vehicle communication apparatus being communicatively connected with the cloud server.

### BRIEF DESCRIPTION OF DRAWINGS

One or more embodiments are illustrated exemplarily by means of figures corresponding thereto in the accompanying drawings, these exemplary illustrations do not constitute limitations of the embodiments, elements in the drawings having the same reference numeral designations represent similar elements, and the figures are not to be limited in scale unless otherwise specified.

FIG. 1 is a schematic diagram showing an application environment according to an embodiment of the present disclosure;

FIG. 2 is a communication flow diagram between a vehicle communication apparatus and a cloud server according to an embodiment of the present disclosure;

FIG. 3 is a schematic flow diagram showing a battery data management method according to an embodiment of the present disclosure;

FIG. 4A is a schematic flow diagram showing a battery data management method according to another embodiment of the present disclosure;

FIG. 4B is a schematic flow diagram showing a battery data management method according to still another embodiment of the present disclosure;

FIG. 4C is a schematic flow diagram showing a battery data management method according to still another embodiment of the present disclosure;

FIG. 5A is a schematic flow diagram showing a battery data management method according to still another embodiment of the present disclosure;

FIG. 5B is a schematic flow diagram showing a battery data management method according to still another embodiment of the present disclosure;

FIG. 5C is a schematic flow diagram showing a battery data management method according to still another embodiment of the present disclosure;

FIG. 6A is a schematic structural diagram showing a battery data management apparatus according to an embodiment of the present disclosure;

FIG. 6B is a schematic structural diagram showing a battery data management apparatus according to another embodiment of the present disclosure;

FIG. 6C is a schematic structural diagram showing a battery data management apparatus according to still another embodiment of the present disclosure;

FIG. 7A is a schematic structural diagram showing a battery data management apparatus according to still another embodiment of the present disclosure;

FIG. 7B is a schematic structural diagram showing a battery data management apparatus according to still another embodiment of the present disclosure;

FIG. 7C is a schematic structural diagram showing a battery data management apparatus according to still another embodiment of the present disclosure;

FIG. 8 is a schematic structural diagram showing a hardware of a cloud server according to an embodiment of the present disclosure; and

FIG. 9 is a schematic structural diagram showing a hardware of a vehicle communication apparatus according to an embodiment of the present disclosure.

### DETAILED DESCRIPTION

For the that the objects, aspects and advantages of the present disclosure may be more clearly understood, a more particular description of the present disclosure, briefly summarized below, may be had by reference to the accompanying drawings and embodiments. It should be understood that the particular embodiments described herein are illustrative only and are not restrictive. Based on the embodiments in the present disclosure, all other embodiments obtained by a person skilled in the art without involving any inventive effort are within the scope of protection of the present disclosure.

It should be noted that, if not in conflict, the various features of the embodiments of the present disclosure may be combined with of the present disclosure. Additionally, while functional module divisions are performed in device schematics, with logical sequences shown in flowcharts, in some cases, steps shown or described may be performed in a different order than the block divisions in devices, or in flowcharts. Furthermore, the words “first,” “second,” “third,” and the like, as used herein do not limit the data and order of execution, but merely distinguish the same item or similar item having substantially the same function or action.

A cloud server provided by an embodiment of the present disclosure can execute a battery data management method for a vehicle as set forth in a corresponding embodiment below, where the cloud server here can be a physical server or a logical server formed by virtualizing a plurality of physical servers. The cloud server may also be a server group formed by a plurality of servers capable of communicatively connected with each other, and each functional module may be distributed on each server in the server cluster.

A vehicle communication apparatus provided by an embodiment of the present disclosure may perform the vehicle data management method described in the corresponding embodiment below, where the vehicle communication apparatus herein may be any device that can communicate with a vehicle, for example, a Vehicle Communication Interface (VCI), a charging post, a Vehicle Network Intelligent Terminal Equipment (T-Box), or other devices.

### Embodiment 1

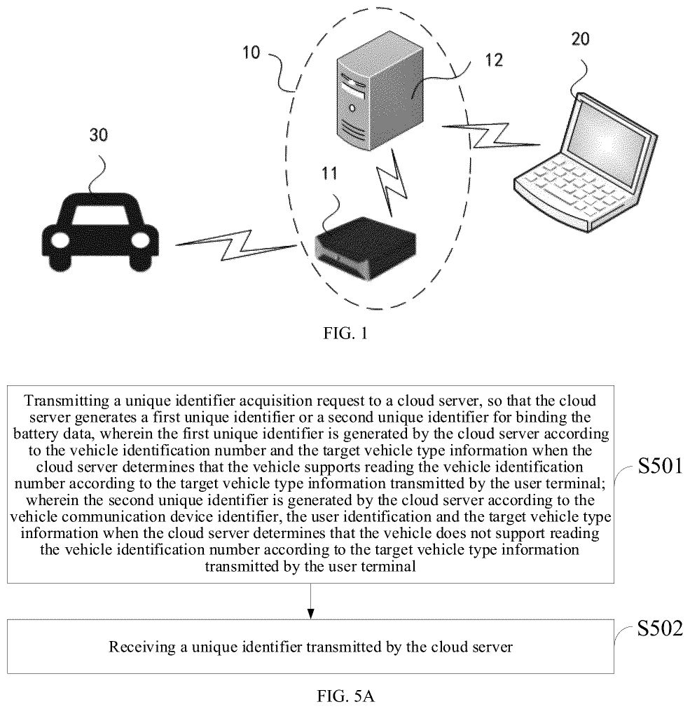

This embodiment provides an application environment. Referring to FIG. 1, the application environment includes a battery data management system 10, a user terminal 20, and a vehicle 30. The battery data management system 10 includes a vehicle communication apparatus 11 and a cloud server 12. The vehicle communication apparatus 11 is used for respectively communicatively connected with the vehicle 20 and the cloud server 12, and the cloud server 12 is also used for communicatively connected with the user terminal 20, where the communication connection includes a wired communication connection or a wireless communication connection, where the wired communication connection includes various types of communication connections for transmitting information using tangible media such as metal wires and optical fibers. Wireless communication connections include 5G communication, 4G communication, 3G communication, 2G communication, CDMA, Zig-Bee, Bluetooth, Wireless Broadband (Wi-Fi), Ultra-wide Band (UWB) and Near Field Communication (NFC), CDMA2000, GSM, Infrared (IR), ISM, RFID, UMTS/3GPPw/HSDPA, WiMAXWi-Fi or ZigBee, etc.

The vehicle communication apparatus 11 is used for interacting with the cloud server 12 and the vehicle 30, and in the process of interacting with the cloud server 12, the vehicle communication apparatus 11 can transmit various types of requests or data to the cloud server 12 and receive various types of data transmitted by the cloud server 12. The vehicle communication apparatus 11 may transmit various types of data or instructions to the vehicle 30 and receive various types of vehicle data or information transmitted by the vehicle 30 during interaction with the vehicle 30.

The cloud server 12 is used for interacting with the vehicle communication apparatus 11 and the user terminal 20, and can receive various types of requests, data transmitted by the vehicle communication apparatus 11 and the user terminal 20 or transmit various types of data to the vehicle communication apparatus 11 and the user terminal 20. In addition, the cloud server 12 can perform functions such as archiving and storing battery data of the vehicle 30 as a battery data management backstage of the vehicle 30.

The user terminal 20 is used for interacting with the cloud server 12, and can receive various types of data transmitted by the cloud server 12 or transmit various types of requests and data to the cloud server 12. For example, the user terminal 20 is installed with an application, and after the user terminal 20 logs into the application, interaction with the cloud server 12 is realized. The user terminal 20 may include a desktop computer, smartphone, tablet computer, or other terminal devices.

The vehicle 30 may be any type of vehicle, such as a car, bus, heavy truck, etc. An electronic control unit (ECU) is provided in the vehicle 30, the ECU records all the data/parameters of the vehicle 30, the vehicle 30 can perform a be communicatively connected with the vehicle communication apparatus 11 via the ECU, and during the communication connection, the ECU can receive various types of instructions transmitted by the vehicle communication apparatus 11 and transmit various types of data/parameters to the vehicle communication apparatus 11.

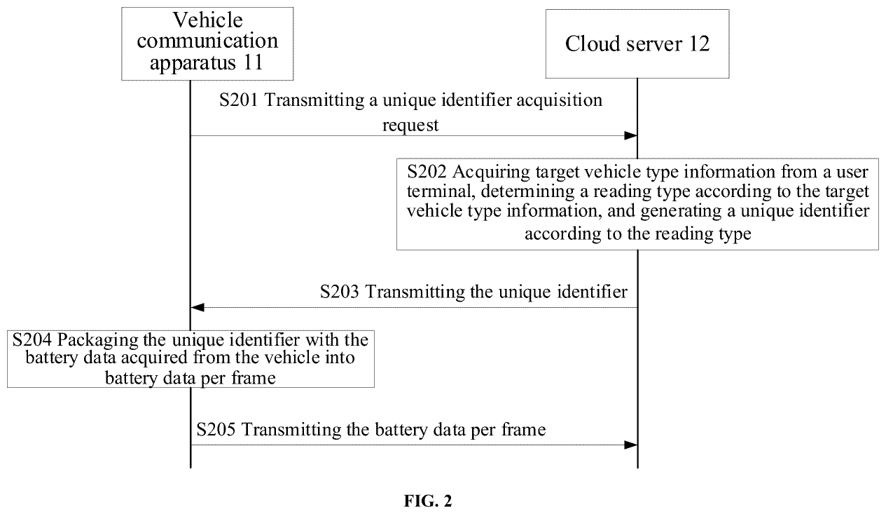

Referring to FIG. 2, the battery data management flow between the vehicle communication apparatus 11 and the cloud server 12 is as follows:
S201: the vehicle communication apparatus 11 transmitting a unique identifier acquisition request to the cloud server 12;
S202: after receiving the unique identifier acquisition request, the cloud server 12 acquiring target vehicle type information from the user terminal 20, determining a reading type according to the target vehicle type information, and generating a unique identifier according to the reading type;
S203: the cloud server 12 transmitting the unique identifier to the vehicle communication apparatus 11;
S204: the vehicle communication apparatus 11 packaging the unique identifier and the battery data acquired from the vehicle into battery data per frame; and
S205: the vehicle communication apparatus 11 transmitting the battery data per frame to the cloud server 12.

It will be appreciated that the battery data management flow described above is one embodiment enumerated herein, and that in some embodiments, the battery data management system 10 may employ other battery data management flows.

With the battery data management method for a vehicle, the system, the cloud server and the vehicle communication apparatus according to the embodiments of the present disclosure, a unique identifier that can bind the battery data acquired by the vehicle communication apparatus from the vehicle is generated by the cloud server, thus it is possible to reliably manage the battery data, ensure that the source of the battery data belonging to a specific battery is accurately and uniquely matched, so as to establish twin data according to the battery data of a plurality of historical time periods of the specific battery at a later time, and accurately evaluate the health status of the specific battery.

### Embodiment 2

An embodiment of the present disclosure provides a battery data management method for a vehicle, which is applied to a battery data management system 10. Referring to FIG. 3, the method includes:
S301: the vehicle communication apparatus 11 transmitting a unique identifier acquisition request to the cloud server 12, where the unique identifier is used for binding battery data acquired by the vehicle communication apparatus 11 from the vehicle 30;
As an example rather than a limitation, the unique identifier is used to uniquely determine or match corresponding battery data. In some embodiments, the unique identifier may be composed of arbitrary characters, e.g. Arabic numerals, letters, punctuation marks, etc.
S302: after receiving the unique identifier acquisition request, the cloud server 12 acquiring target vehicle type information from the user terminal 20, and determining whether the vehicle supports reading a vehicle identification number according to the target vehicle type information;
As an example rather than a limitation, the target vehicle type information is vehicle type information corresponding to the vehicle 30, and the target vehicle type information includes, but is not limited to, the following vehicle type information: manufacturer, model, year, battery version, reading type of Vehicle Identification Number (VIN), etc. In some embodiments, the target vehicle type information includes a reading type of the vehicle identification number, the vehicle identification number is used for uniquely determining the corresponding vehicle, and the reading type of the vehicle identification number includes an automatic reading type and a non-automatic reading type, and if the reading type of the vehicle identification number of the corresponding vehicle is the automatic reading type, it is indicated that the vehicle communication apparatus 11 can read the vehicle identification number from the corresponding vehicle by means of a reading instruction, that is, the corresponding vehicle supports reading the vehicle identification number, and if the reading type of the vehicle identification number of the corresponding vehicle is the non-automatic reading type, it is indicated that the vehicle communication apparatus 11 cannot read the vehicle identification number from the corresponding vehicle by the reading instruction, that is, the corresponding vehicle does not support reading the vehicle identification number.

A user can operate a user terminal 20, and logs in a specific application using a user account; after the login is successful, the user can select vehicle type information corresponding to a vehicle 30 in a vehicle type database provided in an interface of the specific application as target vehicle type information; and after the selection is completed, the user terminal 20 transmits the target vehicle type information to a cloud server.
S303: in response to a first determination that the vehicle 30 supports reading the vehicle identification number, the cloud server 12 acquiring the vehicle identification number via the vehicle communication apparatus 11, generating a first unique identifier according to the vehicle identification number and the target vehicle type information, and transmitting the first unique identifier to the vehicle communication apparatus 11;
As an example rather than a limitation, when it is determined that the vehicle 30 supports reading the vehicle identification number, the cloud server 12 searches for a reading instruction corresponding to the target vehicle type information in the pre-set vehicle type database and transmits the reading instruction to the vehicle communication apparatus 11, and the vehicle communication apparatus 11 reads the vehicle identification number of the vehicle 30 according to the reading instruction and transmits the vehicle identification number to the cloud server 12, where the pre-set vehicle type database stores the corresponding relationship between the vehicle type information and the reading instruction, and the cloud server 12 can search the pre-set vehicle type database through the target vehicle type information to determine the reading instruction corresponding to the target vehicle type information.

After receiving the first unique identifier transmitted from the cloud server 12, the vehicle communication apparatus 11 packages the first unique identifier and the battery data into battery data per frame, and transmits the battery data per frame to the cloud server 12. In addition, the vehicle communication apparatus 11 stores the received first unique identifier as a local unique identifier for multiplexing so that the subsequent vehicle communication apparatus 11 packages the real-time acquired battery data and the local unique identifier into battery data per frame.

It is worth mentioning that when the cloud server 12 transmits the first unique identifier to the vehicle communication apparatus 11, corresponding configuration file is also transmitted to the vehicle communication apparatus 11, and since the corresponding vehicle 30 supports reading the vehicle identification number, i.e., the cloud server 12 can acquire the vehicle identification number via the vehicle communication apparatus 11, the corresponding configuration file includes the vehicle identification number. The vehicle communication apparatus 11 stores the received configuration file as a local configuration file, and accordingly, the vehicle identification number in the local configuration file is used as a local vehicle identification number.

S304: in response to a second determination that the vehicle 30 does not support reading the vehicle identification number, the cloud server 12 acquires the vehicle communication apparatus identification from the vehicle communication apparatus 11 and the user identification from the user terminal 20, generates a second unique identifier according to the vehicle communication apparatus identification, the user identification, and the target vehicle type information, and transmits the second unique identifier to the vehicle communication apparatus 11.

As an example rather than a limitation, the vehicle communication apparatus identification is used to uniquely determine a corresponding vehicle communication apparatus. The vehicle communication apparatus identification may be composed of any characters, for example, an Arabic numeral, a letter, a punctuation mark, etc. In some embodiments, the vehicle communication apparatus identification is a serial number of the vehicle communication apparatus. After the vehicle communication apparatus 11 is communicatively connected with the cloud server 12, the vehicle communication apparatus 11 may upload the vehicle communication apparatus identification to the cloud server 12.

The user identification is used to uniquely identify the corresponding user, and in some embodiments, the user identification is an account number that the user logs into a particular application. A user can operate a user terminal 20, and uses a specific application to register an account; the user terminal 20 will transmit registration information to the cloud server 12, where the registration information includes an account to be registered and a password thereof; and the cloud server 12 allocates an account which is authorized and authenticated to the user according to the registration information. When the user completes the registration, the user can log in to a specific application using the account which is authorized and authenticated, and after successful login, the cloud server 12 can acquire the account number (user identification) of the user.

After receiving the second unique identifier transmitted from the cloud server 12, the vehicle communication apparatus 11 packages the first unique identifier and the battery data into battery data per frame, and transmits the battery data per frame to the cloud server 12. In addition, the vehicle communication apparatus 11 stores the received second unique identifier as a local unique identifier for multiplexing so that the subsequent vehicle communication apparatus 11 packages the real-time acquired battery data and the local unique identifier into battery data per frame.

It is worth mentioning that when the cloud server 12 transmits the second unique identifier to the vehicle communication apparatus 11, corresponding configuration file is also transmitted to the vehicle communication apparatus 11, and since the corresponding vehicle 30 does not support reading the vehicle identification number, i.e., the cloud server 12 cannot acquire the vehicle identification number via the vehicle communication apparatus 11, the corresponding configuration file does not include the vehicle identification number. The vehicle communication apparatus 11 stores the received configuration file as a local configuration file.

It can be understood that since the data, algorithms, and the like corresponding to different types of batteries, batteries of the same type but from different manufacturers or batches are different, the battery version information of different vehicles is generally different, and if the battery version information cannot be obtained, the battery data cannot be reliably managed; therefore, the cloud server 12 can obtain the corresponding battery version information according to the target vehicle type information. Since the vehicle cannot be uniquely identified by means of corresponding target vehicle type information, but may uniquely identified by means of the corresponding vehicle identification number, the battery data of the corresponding vehicle may be uniquely identified by the first unique identifier generated according to the vehicle identification number and the target vehicle type information, thereby reliably managing the battery data corresponding to the particular vehicle.

As previously stated, if the corresponding vehicle 30 does not support reading the vehicle identification number, i.e., the cloud server 12 cannot obtain the vehicle identification number via the vehicle communication apparatus 11, the cloud server 12 cannot generate the first unique identifier according to the vehicle identification number and the target vehicle type information; however, the cloud server 12 can generate a second unique identifier according to the target vehicle type information, the vehicle communication apparatus identification and the user identification, and the battery data of the corresponding vehicle can also be uniquely determined by the second unique identifier, thereby reliably managing the battery data corresponding to the specific vehicle.

For example, suppose that a user A owns a vehicle A1, a user B owns a vehicle B1, the vehicle A1 is equipped with a vehicle communication apparatus A2, the vehicle B1 is equipped with a vehicle communication apparatus B2, the user A registers an account A3 for the vehicle A1, the user B registers an account B3 for the vehicle B1, the user A logs in a specific application through the account A3, and binds the vehicle communication apparatus A2 with the account A3 after successful login, and the user B logs in the specific application through the account B3, and binds the vehicle communication apparatus B2 with the account B3 after successful login.

If the account number A3 of the user A is always bound to the vehicle communication apparatus A2, i.e., the vehicle communication apparatus A2 is always mounted on the vehicle A1, the vehicle communication apparatus A2 can determine a corresponding vehicle, and the cloud server 12 can generate an identifier according to the identification of the vehicle communication apparatus A2 and the target vehicle type information; however, when the user A replaces the vehicle communication apparatus A2 mounted on the vehicle A1 with the vehicle communication apparatus B2, the user B replaces the vehicle communication apparatus B2 mounted on the vehicle B1 with the vehicle communication apparatus A2, and if the account number is not taken into account, the cloud server 12 generates and transmits an identifier to the vehicle communication apparatus A2 according to the identification of the vehicle communication apparatus A2 and the target vehicle type information, the vehicle communication apparatus A2 packages the identifier with the battery data of the vehicle B1 into battery data per frame, and the cloud server 12 stores the battery data per frame in a vehicle type file generated according to the identifier. However, in practice, the vehicle type file is used for storing the battery data of the vehicle A1, thereby causing the twin data to be discontinuous in time, thereby failing to accurately evaluate the vehicle health status.

Therefore, the identifier generated from the vehicle communication apparatus identification and the target vehicle type information does not uniquely determine the battery data of the corresponding vehicle. And when the corresponding vehicle 30 does not support reading the vehicle identification number, the cloud server 12 generates a unique identifier according to the vehicle communication apparatus identification, the user identification (account number) and the target vehicle type information, where the unique identifier can uniquely determine the battery data of the corresponding vehicle and ensure that the battery data source of the corresponding vehicle is continuous in time, that is to say, the temporal continuity of the twin data can be ensured.

As can be appreciated, in the present embodiment, flexibility of battery data management can be improved by allowing a user to unbind a bound vehicle communication apparatus or bind a new vehicle communication apparatus under his or her account on the basis of ensuring temporal continuity of the twin data. In addition, by introducing user identification (account number) for authority identification, users cannot not be informed of the data of other users, so as to ensure the privacy or security of data.

Thus, in the present embodiment, the battery data can be reliably managed to ensure that the source of the battery data belonging to a specific battery is accurately and uniquely matched, so that the twin data can be later established based on the battery data of a plurality of historical time periods of the specific battery to accurately assess the health status of the specific battery.

In addition, in the present embodiment, the case where the vehicle supports reading the vehicle identification number and the case where the vehicle does not support reading the vehicle identification number are both considered, and in any case, it is possible to generate a unique identifier that can uniquely determine the battery data of the corresponding vehicle, thereby ensuring reliable management of the battery data while increasing the flexibility of unique identifier generation.

Note that the “unique identifier” described herein may be any one of the “first unique identifier” and the “second unique identifier” described herein.

In some embodiments, after generating a second unique identifier according to the vehicle communication apparatus identifier, the user identification and the target vehicle type information, the cloud server 12 creates a vehicle type file according to the second unique identifier, and the vehicle type file uniquely determines battery data of the corresponding vehicle for storing the battery data of the corresponding vehicle, which is equivalent to creating a database of the battery data of the corresponding vehicle.

It can be understood that after the cloud server 12 generates the second unique identifier, the second unique identifier is transmitted to the vehicle communication apparatus 11; the vehicle communication apparatus 11 packages the second unique identifier and the battery data into battery data per frame, and transmits the battery data per frame to the cloud server 12; and the cloud server 12 stores the battery data per frame into a vehicle type file corresponding to the second unique identifier.

In some embodiments, when it is determined that the vehicle does not support reading the vehicle identification number, the cloud server 12 accesses a target account of the user terminal 20, and determines whether the vehicle type information about the vehicle type file in a target account matches the target vehicle type information; when it is determined matching, it is indicated that the vehicle type file including the target vehicle type information already exists under the target account, and the cloud server 12 selects a unique identifier of the vehicle type file to transmit to the vehicle communication apparatus 11, without generating a second unique identifier by the cloud server 12 according to the vehicle communication apparatus identifier, the user identification and the target vehicle type information. When it is determined not matching, it means that there is no vehicle type file including the target vehicle type information under the target account, and the cloud server 12 needs to generate a second unique identifier according to the vehicle communication apparatus identification, the user identification and the target vehicle type information.

In some embodiments, before the vehicle communication apparatus 11 transmits the unique identifier acquisition request to the cloud server 12, the vehicle communication apparatus 11 determines a plugging state of the vehicle 30 and the vehicle communication apparatus 11; in response to determining that the plugging state is a plugged state, the vehicle communication apparatus 11 reads an identification number to be verified of the vehicle according to a local configuration file, and determines whether the identification number to be verified matches the local vehicle identification number; as previously stated, the local configuration file corresponds to the local unique identifier; and if the unique identifier is generated according to the vehicle identification number and target vehicle type information, the local configuration file includes a corresponding vehicle identification number (a local identification number); therefore, if the identification number to be verified matches the local vehicle identification number, it is indicated that the local unique identifier is a unique identifier which can uniquely determine the battery data of the vehicle and is transmitted by the cloud server 12; then the vehicle communication apparatus 11 can select the local unique identifier as the unique identifier; if the identification number to be verified does not match the local vehicle identification number, it is indicated that the local unique identifier is not a unique identifier which can uniquely determine the battery data of the vehicle and is transmitted by the cloud server 12; then the vehicle communication apparatus 11 needs to transmit a unique identifier acquisition request to the cloud server 12 so that the cloud server 12 generates a unique identifier that can uniquely determine the battery data of the vehicle and returns the unique identifier.

For example, it is assumed that the preceding vehicle in the plugged state with the vehicle communication apparatus 11 is the vehicle C1, and the following vehicle in the plugged state with the vehicle communication apparatus 11 is the vehicle D1. If the vehicle C1 and the vehicle D1 are the same vehicle and both support reading the vehicle identification number, and the vehicle communication apparatus 11 stores a unique identifier and a configuration file corresponding to the vehicle C1 (the configuration file includes the vehicle identification number of the vehicle C1), then when the vehicle communication apparatus 11 and the vehicle D1 are in a plugged state, the vehicle communication apparatus 11 reads the identification number to be verified of the vehicle D1 according to the local configuration file, and the vehicle communication apparatus 11 determines that the identification number to be verified matches the local vehicle identification number, and selects the local unique identifier as the unique identifier.

In some embodiments, in response to determining that the plugging state is an unplugged state, the vehicle communication apparatus selects a local unique identifier as the unique identifier.

### Embodiment 3

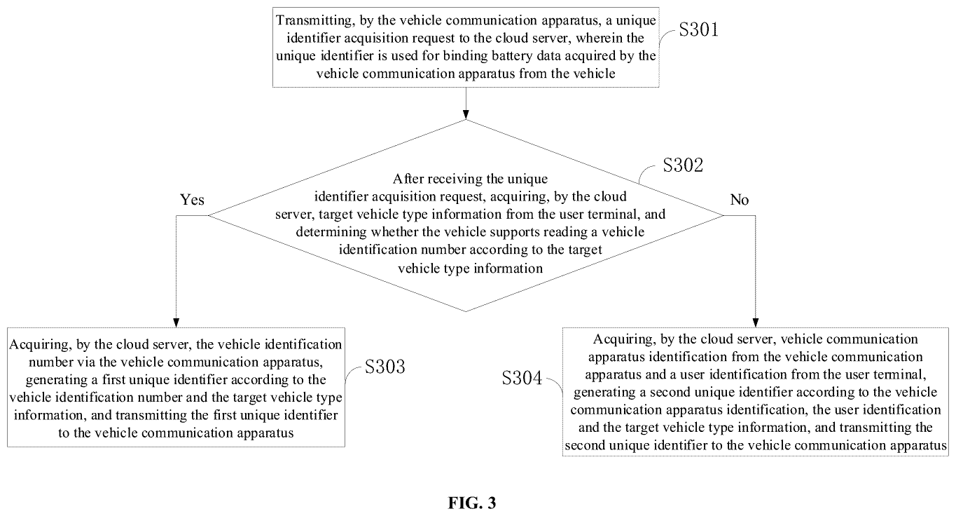

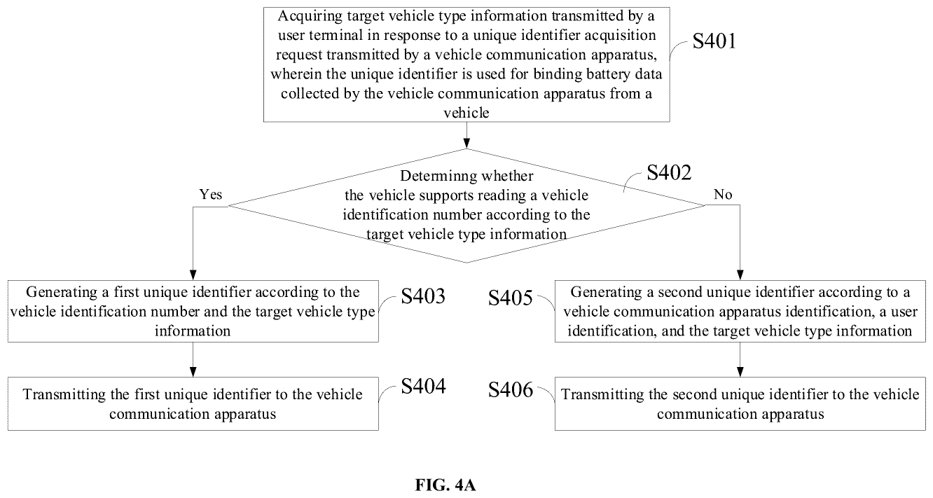

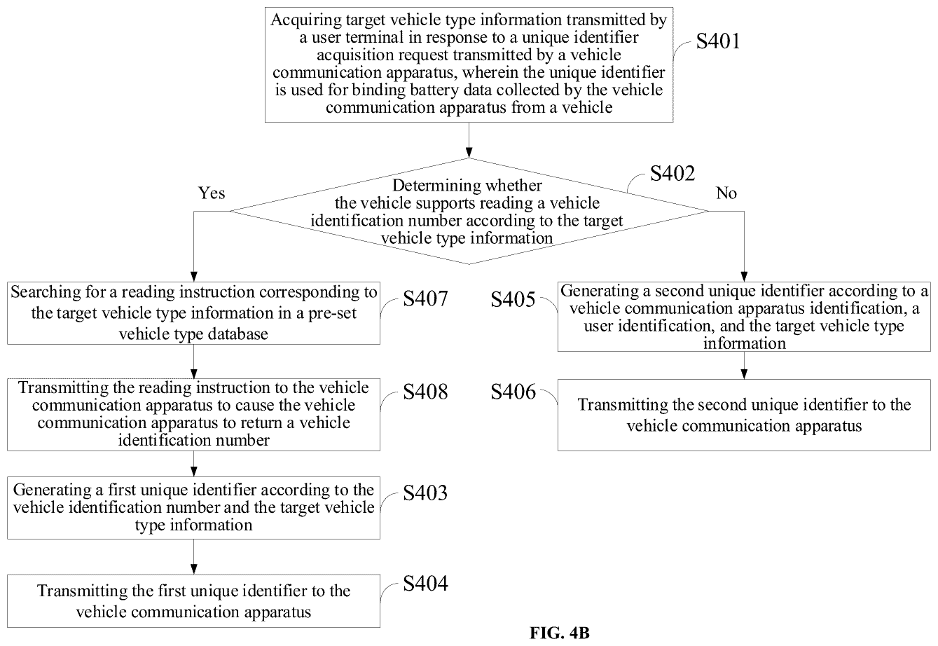

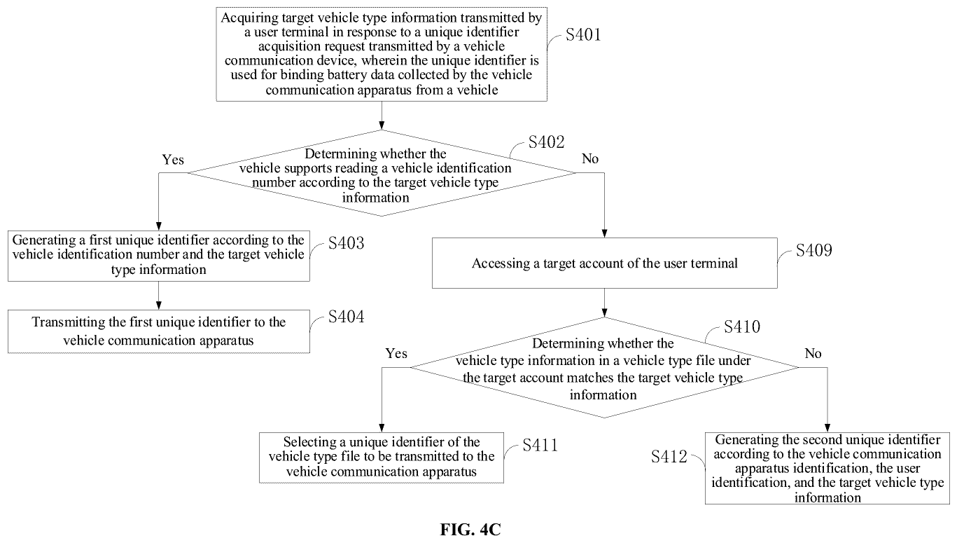

An embodiment of the present disclosure provides a battery data management method for a vehicle, where in the present embodiment, a cloud server is selected as an executive subject to execute the battery data management method provided by the present embodiment. Referring to FIG. 4A, the battery data management method includes:
S401: acquiring target vehicle type information transmitted by a user terminal in response to a unique identifier acquisition request transmitted by a vehicle communication apparatus, where the unique identifier is used for binding battery data acquired by the vehicle communication apparatus from a vehicle;
S402: determining whether the vehicle supports reading a vehicle identification number according to the target vehicle type information;
S403: generating a first unique identifier according to the vehicle identification number and the target vehicle type information in response to a first determination that the vehicle supports reading the vehicle identification number;
S404: transmitting the first unique identifier to the vehicle communication apparatus;
S405: generating a second unique identifier according to a vehicle communication apparatus identification, a user identification, and the target vehicle type information in response to a second determination that the vehicle does not support reading the vehicle identification number; and
S406: transmitting the second unique identifier to the vehicle communication apparatus.

Thus, in the present embodiment, the battery data can be reliably managed to ensure that the source of the battery data belonging to a specific battery is accurately and uniquely matched, so that the twin data is later established based on the battery data of a plurality of historical time periods of the specific battery to accurately assess the health status of the specific battery.

In addition, in the present embodiment, the case where the vehicle supports reading the vehicle identification number and the case where the vehicle does not support reading the vehicle identification number are both considered, and in any case, it is possible for the cloud server to generate a unique identifier that can uniquely determine the battery data of the corresponding vehicle, thereby ensuring reliable management of the battery data while increasing the flexibility of unique identifier generation.

In some embodiments, referring to FIG. 4B, the battery data management method further includes:
S407: in response to a first determination that the vehicle supports reading the vehicle identification number, searching for a reading instruction corresponding to the target vehicle type information in a pre-set vehicle type database;
S408: transmitting a reading instruction to the vehicle communication apparatus, to cause the vehicle communication apparatus to return a vehicle identification number that the vehicle communication apparatus has read from the vehicle according to the reading instruction.

In some embodiments, referring to FIG. 4C, the battery data management method further includes:
S409: in response to a second determination that the vehicle does not support reading the vehicle identification number, accessing a target account of the user terminal;
S410: in response to a second determination that the vehicle does not support reading the vehicle identification number, accessing a target account of the user terminal;
S411: in response to determining matching, selecting a unique identifier of the vehicle type file to be transmitted to the vehicle communication apparatus; and
S412: in response to determining not matching, generating the second unique identifier according to the vehicle communication apparatus identification, the user identification, and the target vehicle type information.

### Embodiment 4

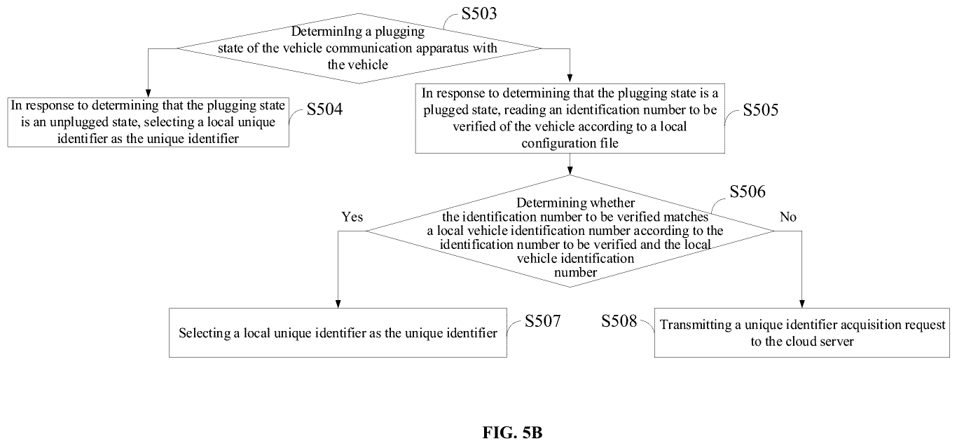

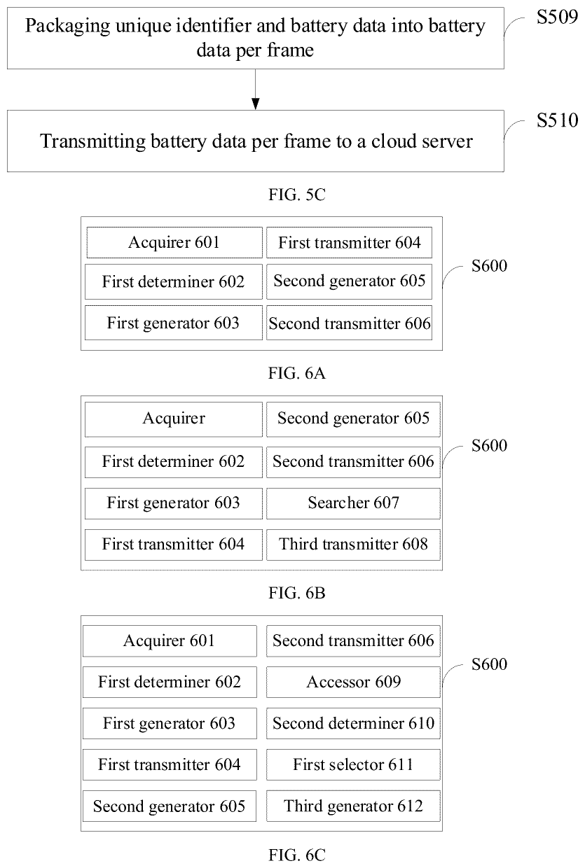

An embodiment of the present disclosure provides a battery data management method for a vehicle, where in the present embodiment, a vehicle communication apparatus is selected as an executive subject to execute the battery data management method provided by the present embodiment. Referring to FIG. 5A, the battery data management method includes:
S501: transmitting a unique identifier acquisition request to a cloud server, so that the cloud server generates a first unique identifier or a second unique identifier for binding the battery data, where the first unique identifier is generated by the cloud server according to the vehicle identification number and the target vehicle type information when the cloud server determines that the vehicle supports reading the vehicle identification number based on the target vehicle type information transmitted by the user terminal; where the second unique identifier is generated by the cloud server according to the vehicle communication apparatus identifier, the user identification and the target vehicle type information when the cloud server determines that the vehicle does not support reading the vehicle identification number based on the target vehicle type information transmitted by the user terminal;
S502: receiving the unique identifier transmitted by the cloud server.

In some embodiments, before performing S501, referring to FIG. 5B, the battery data management method further includes:
S503: determining a plugging state of the vehicle communication apparatus with the vehicle;
S504: in response to determining that the plugging state is an unplugged state, selecting a local unique identifier as the unique identifier;
S505: in response to determining that the plugging state is a plugged state, reading an identification number to be verified of the vehicle according to a local configuration file;
S506: determining whether the identification number to be verified matches a local vehicle identification number according to the identification number to be verified and the local vehicle identification number;
S507: in response to determining matching, selecting a local unique identifier as the unique identifier;
S508: in response to determining not matching, transmitting a unique identifier acquisition request to the cloud server.

In some embodiments, referring to FIG. 5C, the battery data management method further includes:
S509: packaging the unique identifier and battery data into battery data per frame; and
S510: transmitting the battery data per frame is to the cloud server.

### Embodiment 5

Embodiments of the present disclosure provide a battery data management device for a vehicle. Referring to FIG. 6A, the battery data management device 600 includes an acquirer 601, a first determiner 602, a first generator 603, a first transmitter 604, a second generator 605, and a second transmitter 606.

The acquirer 601 can acquire target vehicle type information transmitted by a user terminal in response to a unique identifier acquisition request transmitted by a vehicle communication apparatus, where the unique identifier is used for binding battery data acquired by the vehicle communication apparatus from the vehicle; the determiner 602 is configured to determine whether the vehicle supports reading a vehicle identification number according to the target vehicle type information; the first generator 603 is configured to generate a first unique identifier according to the vehicle identification number and the target vehicle type information when the vehicle supports reading the vehicle identification number; the first transmitter 604 is configured to transmit the first unique identifier to the vehicle communication apparatus; the second generator 605 is configured to generate a second unique identifier according to the vehicle communication apparatus identification, the user identification, and the target vehicle type information when the vehicle supports reading the vehicle identification number, and the second transmitter 606 is configured to transmit the second unique identifier to the vehicle communication apparatus.

In some embodiments, referring to FIG. 6B, the battery data management device 600 further includes a search module 607 and a third transmitter 608.

The search module 607 is configured to search for a reading instruction corresponding to the target vehicle type information in the pre-set vehicle type database when the vehicle supports reading the vehicle identification number, and the third transmitter 608 is configured to transmit the reading instruction to the vehicle communication apparatus so that the vehicle communication apparatus returns the vehicle identification number, where the vehicle identification number is the vehicle identification number read from the vehicle by the vehicle communication apparatus according to the reading instruction.

In some embodiments, referring to FIG. 6C, the battery data management device 600 further includes an access module 609, a second determiner 610, a first selector 611, and a third generator 612.

The access module 609 is configured to access a target account of the user terminal when the vehicle does not support reading the vehicle identification number; the second determiner 610 determines whether the vehicle type information about the vehicle type file under the target account matches the target vehicle type information; the first selector 611 is configured to select a unique identifier of the vehicle type file to transmit to the vehicle communication apparatus when the vehicle type information about the vehicle type file under the target account matches the target vehicle type information; and the second generator 612 is configured to generate a second unique identifier according to the vehicle communication apparatus identification, the user identification, and the target vehicle type information when the vehicle type information of the vehicle type file under the target account does not match the target vehicle type information.

### Embodiment 6

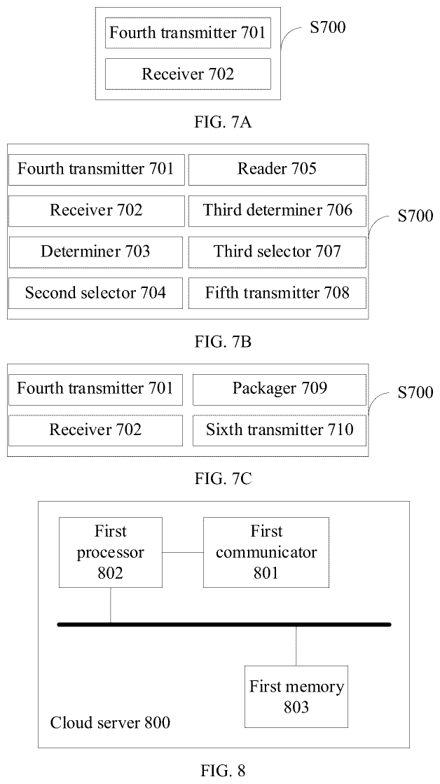

Embodiments of the present disclosure provide a battery data management device for a vehicle. Referring to FIG. 7A, the battery data management device 700 includes a fourth transmitter 701 and a receiver 702.

The fourth transmitter 701 may transmit a unique identifier acquisition request to a cloud server, so that the cloud server generates a first unique identifier or a second unique identifier for binding the battery data, where the first unique identifier is generated by the cloud server according to the vehicle identification number and the target vehicle type information when the cloud server determines that the vehicle supports reading the vehicle identification number according to the target vehicle type information transmitted by the user terminal; where the second unique identifier is generated by the cloud server according to the vehicle communication apparatus identifier, the user identification and the target vehicle type information when the cloud server determines that the vehicle does not support reading the vehicle identification number according to the target vehicle type information transmitted by the user terminal. The receiver 702 may receive the unique identifier transmitted by the cloud server.

In some embodiments, referring to FIG. 7B, the battery data management device 700 further includes a determiner 703, a second selector 704, a reader 705, a third determiner 706, a third selector 707 and a fifth transmitter 708.

The determiner 703 can determine a plugging state of a vehicle communication apparatus and a vehicle; the second selector 704 is configured to select a local unique identifier as a unique identifier when the plugging state is a plugged state; the reader 705 is configured to read an identification number to be verified of the vehicle according to a local configuration file when the plugging state is an unplugged state; a third determiner 706 is configured to determine whether the identification number to be verified matches the local vehicle identification number according to the identification number to be verified and the local vehicle identification number; the third selector 707 is configured to select the local unique identifier as the unique identifier when the identification number to be verified matches the local vehicle identification number; and the fifth transmitter 708 is configured to transmit the unique identifier acquisition request to the cloud server when the identification number to be verified does not match the local vehicle identification number.

In some embodiments, referring to FIG. 7C, the battery data management device 700 also includes a packager 709 and a sixth transmitter 710.

The packager 709 is configured to package the unique identifier and the battery data into battery data per frame, and the sixth transmitter 710 is configured to transmit the battery data per frame to the cloud server.

It should be noted that the above-mentioned battery data management device can execute the battery data management method provided by the embodiments of the present disclosure, and has functional modules and beneficial effects corresponding to the execution method. Technical details not described in detail in the present embodiment of the battery data management device can be found in the battery data management method provided in the present embodiment of the present disclosure.

Referring to FIG. 8, FIG. 8 is a schematic structural diagram showing a hardware of a cloud server provided in an embodiment of the present disclosure. As shown in FIG. 8, the cloud server includes a first communicator 801, one or more first processors 802 and a first memory 803. One first processor 802 is exemplified in FIG. 8.

The first communicator 801 is used to be communicatively connected with the vehicle communication apparatus and the user terminal, and the first processor 81 can realize interaction with the vehicle communication apparatus or with the user terminal by controlling the first communicator 801. The first communicator 801 is also electrically coupled to the first processor 802.

The processors 802 and the memory 803 may be connected via a bus or in other ways, and via a bus connection exemplified in FIG. 8.

The memory 803, as a non-volatile computer-readable storage medium, can be used to store non-volatile software programs, non-volatile computer-executable programs, and modules such as program instructions/modules corresponding to the battery data management method in the present embodiment of the present disclosure. The first processor 802 executes various functional applications of the battery data management device and data processing by executing the non-volatile software programs, instructions and modules stored in the first memory 803, i.e., implements the battery data management method provided by the above-described method embodiment and the functions of the respective modules or units of the above-described device embodiment.

The memory 803 may include a high speed random access memory and may also include a non-volatile memory, such as at least one magnetic disk storage device, flash memory device, or other non-volatile solid state storage devices. In some embodiments, the memory 803 may optionally include memories remotely located with respect to a processor 802, which may be connected to the processor 802 via a network. Examples of such networks include, but are not limited to, the Internet, intranets, local area networks, mobile communication networks, and combinations thereof.

The program instructions/modules are stored in the first memory 803 and when executed by the one or more first processors 802 perform the battery data management method for any one of the method embodiments described above.

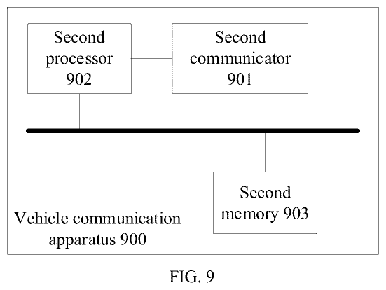

FIG. 9 is a schematic structural diagram showing a hardware of a cloud server provided by an embodiment of the present disclosure. As shown in FIG. 9, the cloud server includes a second communicator 901, one or more second processors 902 and a second memory 903. One second processor 902 being provided is exemplified in FIG. 9.

The first communicator 901 is configured to be communicatively connected with the vehicle and the cloud server, and the second processor 901 can realize interaction with the vehicle or with the cloud server by controlling the first communicator 901. The second communicator 901 is also electrically coupled to the second processor 902.

The processors 902 and the memory 903 may be connected via a bus or in other ways, and via a bus connection exemplified in FIG. 9.

The second memory 903, as a non-volatile computer-readable storage medium, can be used to store non-volatile software programs, non-volatile computer-executable programs, and modules such as program instructions/modules corresponding to the battery data management method in the present embodiment of the present disclosure. The second processor 902 executes various functional applications of the battery data management device and data processing by executing the non-volatile software programs, instructions and modules stored in the second memory 903, i.e., implements the battery data management method provided by the above-described method embodiment and the functions of the respective modules or units of the above-described device embodiment.

The second memory 903 may include a high speed random access memory and may also include a non-volatile memory, such as at least one magnetic disk storage device, flash memory device, or other non-volatile solid state storage devices. In some embodiments, the second memory 903 may optionally include memories remotely located with respect to a second processor 902, which may be connected to the second processor 902 via a network. Examples of such networks include, but are not limited to, the Internet, intranets, local area networks, mobile communication networks, and combinations thereof.

The program instructions/modules are stored in the second memory 903 and when executed by the one or more second processors 92, perform the battery data management method for any one of the method embodiments described above.

Embodiments of the present disclosure also provide a non-volatile computer storage medium having stored thereon computer-executable instructions that, when executed by one or more processors, such as one processor 802 in FIG. 8 or one processor 902 in FIG. 9, may cause the one or more processors to perform the battery data management method in any one of the method embodiments described above.

Embodiments of the present disclosure also provide a computer program product comprising a computer program stored on a non-volatile computer readable storage medium, the computer program comprising program instructions which, when executed by an electronic device, cause the electronic device to perform any one of the battery data management methods described herein.

The device or device embodiments described above are merely illustrative, wherein the unit modules illustrated as separate components may or may not be physically separated, and the components shown as modular units may or may not be physical units, i.e., may be located in one place, or may also be distributed over multiple network modular units. Some or all the modules may be selected according to actual needs to achieve the purpose of the solution of the present embodiment.

The embodiments of the present disclosure may be implemented by means of software plus a general-purpose hardware platform, or by means of hardware. With this in mind, some of the above-described aspects in essence or in a contribution to the art may be embodied in the form of a software product, which may be stored on a readable storage medium, such as an ROM/RAM, magnetic diskette, compact disk, etc. containing instructions for causing a computer device, which may be a personal computer, a server, or a network appliance, etc. to perform the methods of the various embodiments or portions of the embodiments of the present disclosure.

Finally, it is noted that the present disclosure may be embodied in many different forms and should not be construed as limited to the embodiments of the present disclosure set forth herein; rather, these embodiments are provided so that the present disclosure will be thorough and complete. In addition, under the idea of the present disclosure, the above-mentioned technical features continue to be combined with each other, and there are many other changes in different aspects of the present disclosure as described above, all being considered as the scope of disclosure contained in the description of the present disclosure; further, all such modifications and variations are considered to fall within the scope of the appended claims.

The above description is only related to some embodiments of the present disclosure, and the scope of protection of the present disclosure is not limited thereto, and changes or substitutions thereof will readily occur to a person skilled in the art within the scope of the present disclosure, and these are intended to be within the scope of protection of the present disclosure. Therefore, the scope of protection of the present disclosure should be determined by the scope the claims.

1. A battery data management method for a vehicle, applied to a battery data management system, wherein the method comprises:
transmitting, by a vehicle communication apparatus, a unique identifier acquisition request to the cloud server, wherein a unique identifier is configured to bind battery data acquired by the vehicle communication apparatus from the vehicle, wherein the battery data management system comprises the vehicle communication apparatus and a cloud server, the vehicle communication apparatus is configured to be communicatively connected with a vehicle and the cloud server, and the cloud server is configured to be further communicatively connected with a user terminal;
in response to receiving, by the cloud server, the unique identifier acquisition request, acquiring, by the cloud server, target vehicle type information from the user terminal, and determining, by the cloud server, whether the vehicle supports reading a vehicle identification number according to the target vehicle type information; and
in response to a first determination that the vehicle supports reading the vehicle identification number, acquiring, by the cloud server, the vehicle identification number via the vehicle communication apparatus, generating, by the cloud server, a first unique identifier according to the vehicle identification number and the target vehicle type information, and transmitting, by the cloud server, the first unique identifier to the vehicle communication apparatus; or
in response to a second determination that the vehicle does not support reading the vehicle identification number, acquiring, by the cloud server, a vehicle communication device apparatus identification from the vehicle communication apparatus and a user identification from the user terminal, generating, by the cloud server, a second unique identifier according to the vehicle communication apparatus identification, the user identification and the target vehicle type information, and transmitting, by the cloud server, the second unique identifier to the vehicle communication apparatus.

2. The method according to claim 1, further comprising:
in response to the first determination that the vehicle supports reading the vehicle identification number, searching, by the cloud server, for a reading instruction corresponding to the target vehicle type information in a pre-set vehicle type database, and transmitting, by the cloud server, the reading instruction to the vehicle communication apparatus; and
reading, by the vehicle communication apparatus, the vehicle identification number of the vehicle according to the reading instruction, and transmitting, by the vehicle communication apparatus, the vehicle identification number to the cloud server.

3. The method according to claim 1, further comprising:
in response to the second determination that the vehicle does not support reading the vehicle identification number, accessing, by the cloud server, a target account of the user terminal, and determining, by the cloud server, whether the vehicle type information in a vehicle type file under the target account matches the target vehicle type information; and
in response to determining matching, selecting by the cloud server, a unique identifier of the vehicle type file to transmit to the vehicle communication apparatus; or
in response to determining not matching, generating by the cloud server, the second unique identifier according to the vehicle communication apparatus identification, the user identification, and the target vehicle type information.

4. The method according to claim 1, further comprising:
determining by the vehicle communication apparatus, a plugging state of the vehicle with the vehicle communication apparatus before transmitting the unique identifier acquisition request to the cloud server; and
in response to determining that the plugging state is a plugged state, reading, by the vehicle communication apparatus, an identification number to be verified of the vehicle according to a local configuration file, determining by the vehicle communication apparatus, whether the identification number to be verified matches a local vehicle identification number, and in response to determining matching, selecting, by the vehicle communication apparatus, a local unique identifier as the unique identifier, or in response to determining not matching, transmitting, by the vehicle communication apparatus, a unique identifier acquisition request is transmitted to the cloud server; or
in response to determining that the plugging state is an unplugged state, selecting, by the vehicle communication apparatus, a local unique identifier as the unique identifier.

5. The method according to claim 1, further comprising:
after receiving, by the vehicle communication apparatus, the unique identifier, packaging, by the vehicle communication apparatus, the unique identifier and the battery data into battery data per frame, and transmitting, by the vehicle communication apparatus, the battery data per frame to the cloud server.

6. A battery data management method for a vehicle, comprising:
acquiring, by cloud server, target vehicle type information transmitted by a user terminal in response to receiving, by the cloud server, a unique identifier acquisition request transmitted by a vehicle communication apparatus, wherein a unique identifier is configured to bind battery data acquired by the vehicle communication apparatus from a vehicle;
determining, by the cloud server, whether the vehicle supports reading a vehicle identification number according to the target vehicle type information; and
in response to a first determination that the vehicle supports reading the vehicle identification number generating, by the cloud server, a first unique identifier according to the vehicle identification number and the target vehicle type information, and transmitting, by the cloud server, the first unique identifier to the vehicle communication apparatus; or
in response to a second determination that the vehicle does not support reading the vehicle identification number, generating, by the cloud server, a second unique identifier according to a vehicle communication apparatus identification, a user identification, and the target vehicle type information, and transmitting, by the cloud server, the second unique identifier to the vehicle communication apparatus.

7. The method according to claim 6, further comprising:
in response to the first determination that the vehicle supports reading the vehicle identification number, searching, by the cloud server, for a reading instruction corresponding to the target vehicle type information in a pre-set vehicle type database; and
transmitting, by the cloud server, the reading instruction to the vehicle communication apparatus, wherein the vehicle communication apparatus is configured to read the vehicle identification number from the vehicle according to the reading instruction and send the vehicle identification number to the cloud server.

8. The method according to claim 6, further comprising:
in response to the second determination that the vehicle does not support reading the vehicle identification number, accessing, by the cloud server, a target account of the user terminal;
determining, by the cloud server, whether the vehicle type information in a vehicle type file under the target account matches the target vehicle type information; and
in response to determining matching, selecting, by the cloud server, a unique identifier of the vehicle type file to be transmitted to the vehicle communication apparatus; or
in response to determining not matching, generating, by the cloud server, the second unique identifier according to the vehicle communication apparatus identification, the user identification, and the target vehicle type information.

9-11. (canceled)

12. A cloud server, comprising:
a first communicator;
at least one first processor electrically coupled to the first communicator; and
a first memory communicatively connected with the at least one first processor; wherein
the first memory stores instructions executable by the at least one first processor to enable the at least one first processor to perform acts comprising:
acquiring target vehicle type information transmitted by a user terminal in response to receiving a unique identifier acquisition request transmitted by a vehicle communication apparatus, wherein a unique identifier is configured to bind battery data acquired by the vehicle communication apparatus from a vehicle;
determining whether the vehicle supports reading a vehicle identification number according to the target vehicle type information; and
in response to a first determination that the vehicle supports reading the vehicle identification number, generating a first unique identifier according to the vehicle identification number and the target vehicle type information, and transmitting the first unique identifier to the vehicle communication apparatus; or
in response to a second determination that the vehicle does not support reading the vehicle identification number, generating a second unique identifier according to a vehicle communication apparatus identification, a user identification, and the target vehicle type information, and transmitting the second unique identifier to the vehicle communication apparatus.

13-14. (canceled)

15. The method according to claim 2, further comprising:
after receiving, by the vehicle communication apparatus, the unique identifier, packaging, by the vehicle communication apparatus, the unique identifier and the battery data into battery data per frame, and transmitting, by the vehicle communication apparatus, the battery data per frame to the cloud server.

16. The method according to claim 3, further comprising:
after receiving, by the vehicle communication apparatus, the unique identifier, packaging, by the vehicle communication apparatus, the unique identifier and the battery data into battery data per frame, and transmitting, by the vehicle communication apparatus, the battery data per frame to the cloud server.

17. The method according to claim 4, further comprising:
after receiving, by the vehicle communication apparatus, the unique identifier, packaging, by the vehicle communication apparatus, the unique identifier and the battery data into battery data per frame, and transmitting, by the vehicle communication apparatus, the battery data per frame to the cloud server.
